(19) United States
(12) Patent Application Publication
(10) Pub. No.: US 2024/0354423 A1
(43) Pub. Date: Oct. 24, 2024

(54) CYBERSECURITY MANAGEMENT SYSTEMS INTEGRATING ARTIFICIAL INTELLIGENCE, MACHINE LEARNING AND EXTENDED REALITY

(71) Applicant: Teachers Insurance and Annuity Association of America, New York, NY (US)

(72) Inventors: Upendra Mardikar, Fremont, CA (US); Amy Tyndall Braswell, Matthews, NC (US); Rajneel M. Dhotre, Harrisburg, NC (US); Kanan Vaidya, Edison, NJ (US); Brian Gerard, Myrtle Beach, SC (US); Joel Amick, Huntersville, NC (US); Coleman Mack, Lexington, NC (US); Richard Stern, Charlotte, NC (US); Aysha Nahan, Azhikode (IN); Jeffrey Campaz, Charlotte, NC (US); Maxsell Dickey, Charlotte, NC (US); Suresh Krishnamachary, Charlotte, NC (US)

(21) Appl. No.: 18/640,066

(22) Filed: Apr. 19, 2024

Related U.S. Application Data
(60) Provisional application No. 63/460,913, filed on Apr. 21, 2023.

(51) Int. Cl. G06F 21/57; G06F 21/55; G06T 13/40; G06T 19/00; H04L 51/02

(52) U.S. Cl. CPC G06F 21/577; G06F 21/554; G06T 13/40; G06T 19/006; H04L 51/02

(57) ABSTRACT

A method includes ingesting cybersecurity data collected from a set of data sources of a computing system of an enterprise to obtain input data, wherein each data source of the set of data sources generates data related to cybersecurity within the computing system, processing the input data to generate an analysis output comprising an assessment of cybersecurity risk within the computing system, and performing, based on the analysis output, at least one action to manage cybersecurity for the computing system. Performing the at least one action includes at least one of using a digital assistant for managing the cybersecurity of the computing system, or using an extended reality system to access a virtual environment for managing the cybersecurity of the computing system.

### CROSS-REFERENCE TO RELATED APPLICATION(S)

The present application claims priority to U.S. Provisional Patent Application No. 63/460,913, filed on Apr. 21, 2023 and entitled “CYBERSECURITY MANAGEMENT SYSTEMS INTEGRATING ARTIFICIAL INTELLIGENCE, MACHINE LEARNING AND EXTENDED REALITY”, the entire contents of which are hereby incorporated by reference herein.

### TECHNICAL FIELD

Implementations of the disclosure relate generally to database management, and more specifically, relate to cybersecurity management systems integrating artificial intelligence (AI), machine learning (ML) and extended reality (XR).

### BACKGROUND

An enterprise environment can include multiple devices communicably coupled by a private network owned and/or controlled by an enterprise (e.g., organization). An enterprise environment can include an on-premises subnetwork in which software is installed and executed on computers on the premises of the enterprise using the software.

### BRIEF DESCRIPTION OF THE DRAWINGS

The disclosure will be understood more fully from the detailed description given below and from the accompanying drawings of various implementations of the disclosure. The drawings, however, should not be taken to limit the disclosure to the specific implementations, but are for explanation and understanding only.

FIGS. 1A-3 are diagrams of example computer systems to manage cybersecurity integrating artificial intelligence (AI), machine learning (ML) and extended reality (XR), in accordance with some implementations of the present disclosure.

FIGS. 4A-5 are flow diagrams of example methods to implement cybersecurity management systems integrating artificial intelligence (AI), machine learning (ML) and extended reality (XR), in accordance with some implementations of the present disclosure.

FIG. 6 is a block diagram of an example computer system in which implementations of the present disclosure may operate.

### DETAILED DESCRIPTION

Aspects of the present disclosure are directed to cybersecurity management system integrating artificial intelligence (AI), machine learning (ML) and extended reality (XR). A computing system can include multiple devices communicatively coupled via a network. The network can include one or more of: a local area network (LAN) to connect devices within a limited region (e.g., a building), a wide area network (WAN) to connect devices across multiple regions (e.g., using multiple LANs), etc. For example, a computing system can be an enterprise environment overseen by an enterprise. An enterprise environment can include multiple devices communicably coupled by a private network owned and/or controlled by an enterprise (e.g., organization). An enterprise environment can include an on-premises subnetwork in which software is installed and executed on computers on the premises of the enterprise using the software. Additionally or alternatively, an enterprise environment can include a remote subnetwork (e.g., cloud subnetwork) in which software is installed and executed on remote devices (e.g., server farm). An enterprise environment can be used to facilitate access to data and/or data analytics among devices of the private network. Examples of devices of an enterprise environment can include client devices (e.g., user workstations), servers (e.g., web servers, email servers, high performance computing (HPC) servers, database servers and/or virtual private network (VPN) servers), etc.

A computing system overseen by an enterprise can utilize a variety of technology services in order to provide solutions and capabilities to customers and clients. Examples of technology services include services that can implement and/or host technology services internally within a datacenter or other computing environment (i.e., on-premises infrastructure). Additionally or alternatively, enterprise can use remote services providers (e.g., cloud service providers) that implement and host technology services using remote infrastructure (e.g., remote servers). Examples of technology services include software as a service (SaaS), infrastructure as a service (IaaS), platform as a service (PaaS), etc. For example, enterprises can use third party vendors and/or suppliers to provide technology services. Enterprises may also own or partially own subsidiaries or affiliates who provide technology services.

Enterprises can be accountable for managing a computing system that includes on-premises infrastructure, remote infrastructure, subsidiaries/affiliates and/or third-party vendors. For example, enterprises are accountable for understanding technical risks, such as cybersecurity risks, across the computing system (e.g., on-premises infrastructure and/or remote infrastructure) and to make decisions to prioritize a finite set of resources to remediate technical risks. These decisions can be based on manual review of disparate data set reports from a variety of systems within the computing system. Employees/resources are making decisions on how to prioritize a finite set of resources and funding for remediation based on limited, manual data sets.

A computing system can include many products (e.g., applications or tools), such as cybersecurity products, information technology (IT) products, etc. Such products can generate management data (e.g., terabytes of data or petabytes of data) that can be used to manage the computing system, such as remediating cybersecurity risks. The amount of management data generated by such products can be large, such as on the order of at least terabytes or petabytes. It can be difficult and time-consuming to process large amounts of management data to identify meaningful results and to quickly determine the highest priority actionable items for managing the computing system, such as cybersecurity. Moreover, different products can have different formats and semantics for the same attributes of assets or users. In addition, enterprises can be accountable for managing assets (e.g., asset inventory), such as IT assets and operational technology (OT) assets. For example, a computing system can include an Internet-of-Things (IoT) system including multiple IoT devices that may be vulnerable to cyberattacks or hacks. As a result, there may be unseen cybersecurity risks and/or security vulnerabilities that are not being appropriately responded to in an efficient or timely manner. If an enterprise is unable to determine an amount of security risk, security issues and risk items cannot be quickly identified, prioritized, and remediated. To solve this, it can be necessary to organize the data into a common schema that can be used to provide a consolidated real-time and prioritized view of risk posture.

Additionally, some enterprises can report data in tables, graphs, etc. (e.g., presentations). Such modes of data reporting may not enable users to drill down into the data to extrapolate insights into the data, which can be used to make appropriate management decisions. Additionally, it may be desirable to customize data reports depending on the intended audience (e.g., the position of a user within the enterprise). However, some computing systems may not support generation of customized reports, such as through biometrics (e.g., speech synthesis or facial recognition). Additionally, some products are not capable of ingesting a broad range of data as they are focused on specific types of management (e.g., security vulnerability management).

Aspects of the present disclosure address the above and other deficiencies by providing for systems and methods to implement cybersecurity management of a computing system integrating AI/ML and XR. A computing system can be managed by an enterprise. A computing system described herein can include a cybersecurity management system that can employ AI/ML to improve management of cybersecurity within the computing system. Examples of managing cybersecurity within the computing system include visualizing cybersecurity data, performing at least one cybersecurity action, etc.

In some implementations, the cybersecurity management system can enable hyperautomation within the computing system. Hyperautomation, also referred to as digital process automation (DPA) or intelligent process automation (IPA), refers to the integration of multiple technologies and automation applications to create end-to-end automation of entire workflows or processes within a computing system. Hyperautomation can be used to streamline operations, reduce errors, and increase efficiency and productivity. For example, hyperautomation can be used to automate risk mediation workflows across a computing system.

A cybersecurity management system can include an ingestion system that can receive and ingest large amounts of data generated by various products within a computing system for data management, such as data related to entities within the computing system (e.g., enterprise entities, subsidiary entities, vendor entities, and customer entities). Data ingestion refers to the collection and importation of data from various sources for storage into a data storage system (e.g., database). Data ingestion can involve a number of stages, including extraction, transformation and loading (“ETL”). During the extraction stage, data is identified and extracted from data sources. The data can be received from a broad range of data sources within the computing system. For example, the data sources can include components of an IT infrastructure of the computing system (e.g., systems and/or applications). The data may be in various formats, such as structured, semi-structured, or unstructured. Examples of data types include application programming interface (API) feeds, database queries, Portable Document Format (PDF) files, word processing document files, table-structured format files (e.g., comma-separated value (CSV) files), read-only API access to technology assets and data sources such as a public cloud infrastructure, etc. During the transformation stage, the data that is extracted is transformed to generate transformed data. The transformed data has a data format suitable for use by the cybersecurity management system to perform computing system management. Transforming data can include at least one of data cleaning, data validation, data normalization, or data enrichment. During the loading stage, the transformed data is loaded into the data storage system (e.g., database). For example, loading transformed data can include performing batch processing or real-time streaming. Batch processing is a type of data processing in which data is collected, processed, and analyzed in batches, typically at scheduled intervals. In the context of data ingestion, batch processing can include temporarily storing transformed data in a buffer or staging area, and then processing the transformed data in batches at predetermined times. In contrast to batch processing, real-time streaming in a type of data processing in which data is collected, processed and analyzed in real-time or near real-time as it is generated. In the context of data ingestion, real-time streaming can be used in applications. Batch processing can be a cost-effective way to process large amounts of data while minimizing resource usage in some data processing applications. Real-time processing can utilize more resources than batch processing. However, real-time processing can provide benefits that outweigh the costs in some applications that would improve from real-time or near real-time data-driven insights, such as real-time or near real-time cybersecurity monitoring.

In addition to the ingestion system, the cybersecurity management system can further include an analytics engine that can use AI/ML techniques to analyze the data in real-time or near real-time and generate an analysis output based on the analysis. For example, the analysis output can provide an assessment of cybersecurity risk within a computing system. Additionally, the analysis output can be used to perform an action, either automatically without additional user interaction or by generating an alert to have a user perform an action. For example, the action can be a remedial action to mitigate cybersecurity risk.

In some implementations, the cybersecurity management system supports the use of digital assistants that can interact with users to perform tasks. For example, a digital assistant can be a conversational AI platform that can receive a prompt via a user interface, and generate a command from the content of the prompt to use an ML model (e.g., generative AI model) trained to generate an output based on stored data obtained from the multiple components/products within the computing system. In some implementations, the digital assistant is implemented using an interactive digital avatar that graphically interfaces with a user. In some implementations, the digital assistant is implemented as a chatbot. Further details regarding the implementation of digital assistants will be described herein below.

Additionally or alternatively, in some implementations, the cybersecurity management system can employ a computer system that supports XR to improve management of the cybersecurity management system. Examples of XR include virtual reality (VR), augmented reality (AR) and mixed reality (MR). For example, a cybersecurity management system described herein can enable access to a virtual environment that can include one or more virtual worlds that provide an immersive virtual experience for users. More specifically, each virtual world can be a three-dimensional (3D) virtual space accessible to users, where the users can interact with each other and with digital objects in the 3D virtual space. Users can create digital avatars that represent the users within a virtual world. Once inside a virtual world, users can perform various different types of activities, such as explore the virtual world, socialize with other users who are currently present within the virtual world, participate in games and activities supported by the virtual world, buy and sell virtual goods within a virtual marketplace supported by the virtual world, etc. A virtual environment can be generated and maintained using a combination of technologies, such as AI, blockchain, etc. These technologies can enable the creation and storage of large amounts of data that can be used to populate the virtual worlds with digital content, such as digital objects, digital avatars, digital buildings, etc. Further details regarding the implementation of XR to improvement management of a cybersecurity management system.

Implementations described herein can utilize continuous integration and continuous delivery/deployment (CI/CD) methods to automate the various stages of software (e.g., application) development. CI/CD is a solution to the problems integrating new code can cause for development and operations teams. CI/CD introduces ongoing automation and continuous monitoring throughout the software lifecycle, from integration and testing phases to delivery and deployment.

The “CI” in CI/CD stands for continuous integration. CI generally refers to an automated process for developers build and test new code changes, and merged the new code changes to a shared repository. CI provides a solution to the problem of having too many potentially conflicting branches of an application in development.

The “CD” in CI/CD stands for continuous delivery and/or continuous deployment, which are related concepts that sometimes get used interchangeably. Both continuous delivery and continuous deployment generally refer to automating further stages of the CI/CD pipeline. For example, continuous delivery generally means that a developer's software changes are automatically bug tested and uploaded to a repository, where they can then be deployed to a live production environment by the operations team. Continuous delivery provides a solution to the problem of poor visibility and communication between developer and business teams. To that end, the purpose of continuous delivery is to ensure that it takes minimal effort to deploy new code. Continuous deployment can refer to automatically releasing a developer's changes from the repository to production, where it is usable by end users.

Taken together, the operations performed during continuous integration, continuous delivery and continuous deployment can be performed as part of a “CI/CD pipeline” supported by a development and operations (“DevOps”) team working together with either a DevOps or Site Reliability Engineering (SRE) approach. A CI/CD pipeline is a workflow that defines a series of steps to automatically perform the continuous integration, delivery and deployment described above. For example, the series of steps can include a sequence of commands, conditional and/or unconditional execution control transfers, etc.

The series of steps can be grouped into pipeline stages (“stages”), where each stage has a corresponding set of tasks (e.g., jobs) that are executed during the stage. Multiple tasks in a stage can be executed in parallel based on the number of available task execution agents. If every task in a stage is successfully performed, then the CI/CD pipeline can transition to the next stage. If a task in a stage fails, then the CI/CD pipeline can prematurely terminate (in some cases, the CI/CD pipeline can move to the next stage). Examples of CI/CD pipeline stages include a build stage, a test stage, a release stage, and a deploy stage. The build stage can include a compile task that compiles software (e.g., application) to obtain a build. The test stage can include one or more testing tasks that perform one or more automated tests on the build to ensure that the build is ready for release and deployment. After the test stage, the release stage can include a release task to automatically deliver the build to a repository. The deploy stage can include a deploy task to automatically deploy the build into production.

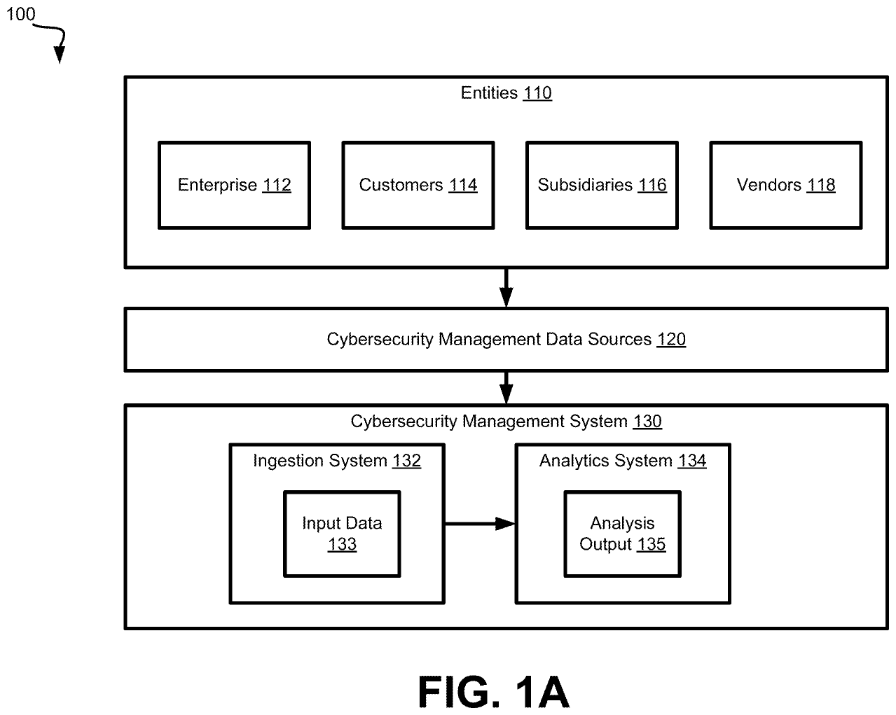

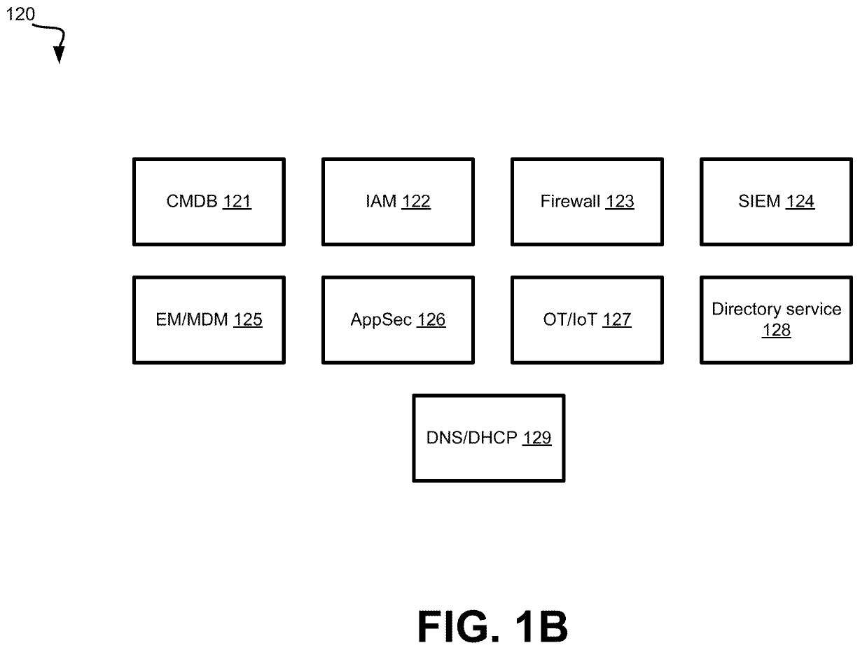

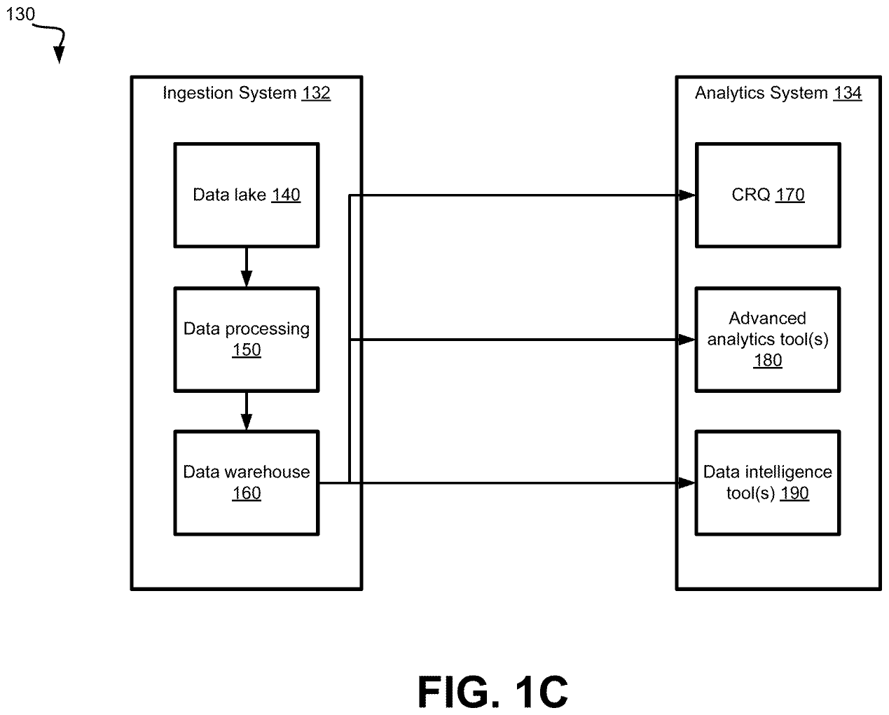

Advantages of the present disclosure include, but are not limited to, improved computer system performance and QoS. For example, implementations described herein can be technology agnostic. Implementations described herein can provide a zero-touch or near-zero-touch (i.e., fully automated or nearly-fully automated) machine learning model to drive end-to-end OS life cycle management. Implementations described herein can provide for a highly flexible and scalable OS lifecycle management solution. Further details regarding cybersecurity management systems that integrate AI, ML and XR will be described in further detail below with reference to FIGS. 1A-6.

FIG. 1A illustrates an example computing system (“system”) 100, in accordance with some implementations of the present disclosure. System 100 can include set of entities (“entities’) 110, cybersecurity management data sources 120 and cybersecurity management system (CMS) 130. In some implementations, System 100 is used within an enterprise and entities 110 correspond to entities of the enterprise. For example, as shown in FIG. 1A, entities 110 can include enterprise entities (“enterprise”) 112, one or more customers of the enterprise (“customers”) 114, one or more subsidiaries of the enterprise (“subsidiaries”) 116 and/or vendors of the enterprise (“vendors”) 118.

Cybersecurity management data sources 120 can include various different IT components related to cybersecurity management of enterprise 112. As an illustrative example, cybersecurity data can include threat intelligence data, such as penetration testing data associated with a penetration test. A penetration test can refer to a simulated cyberattack that is used to identify and/or exploit security vulnerabilities before an actual cyberattack occurs. In some implementations, cybersecurity management data sources 120 include one or more structured data sources. In some implementations, cybersecurity management data sources 120 include one or more unstructured data sources. In some implementations, cybersecurity management data sources 120 include one or more semi-structured data sources. Structured data sources, unstructured data sources and/or semi-structured data sources can include components of cybersecurity management data sources of the computing system (e.g., systems and/or applications). Examples of data that can be obtained from structured data sources, unstructured data sources and/or semi-structured data sources 230 can include vulnerability assessment data, CMDB data associated with a CMDB, IAM data associated with an IAM system, firewall data associated with a firewall, SIEM data associated with a SIEM system, EM data associated with an EM system, MDM data associated with an MDM system, AppSec data associated with an AppSec system, OT management data associated with an OT system, IoT management data associated with an loT system, directory service data associated with a directory service, DNS data associated with a DNS, DHCP data associated with a DHCP, and/or threat intelligence data, such as penetration testing data associated with a penetration test (e.g., a simulated cyberattack that is used to identify and/or exploit security vulnerabilities before an actual cyberattack occurs). Examples of different types of cybersecurity management data sources 120 from which cybersecurity data can be generated will be described below with reference to FIG. 1B.

For example, as shown, CMS 130 can include ingestion system 132 to ingest data to generate input data 133. Ingestion system 132 can ingest large amounts of data generated by various data sources within system 100, such as data related to entities 110 (e.g., enterprise 112, customers 114, subsidiaries 116 and/or customer vendors 118) and/or cybersecurity management data sources 120. CMS 130 can ingest a wide variety of input types such as application programming interface (API) feeds, database queries, unstructured data (e.g., Portable Document Format (PDF) files, word processing document files, table-structured format files (e.g., comma-separated value (CSV) files), read-only API access to technology assets and data sources such as a public cloud infrastructure, etc. CMS 130 can generate an analysis output based on the data. For example, the analysis output can provide an assessment of cybersecurity risk within a computing system. Additionally, the analysis output can be used to perform at least one action, either automatically without additional user interaction or by generating an alert to have a user perform at least one action. For example, the at least one action can include a remedial action to mitigate cybersecurity risk.

Data ingestion performed by ingestion system 132 to generate input data 133 can involve a number of stages, including extraction, transformation and loading (“ETL”). During the extraction stage, data 131 is identified and extracted from at least one data source. The data can be received from a broad range of data sources within the computing system. For example, the data sources can include components cybersecurity management data sources 120 (e.g., systems and/or applications). The data may be in various formats, such as structured, semi-structured, or unstructured. Examples of data types include API feeds, database queries, PDF files, word processing document files, table-structured format files (e.g., CSV files), read-only API access to technology assets and data sources such as a public cloud infrastructure, etc. During the transformation stage, data 131 is transformed to generate input data 133. Input data 133 can have a data format suitable for use by CMS 130 to manage system 100. Transforming data 131 can include at least one of data cleaning, data validation, data normalization, or data enrichment. During the loading stage, input data 133 is loaded into a data storage system (e.g., database). For example, loading input data 133 can include performing batch processing or real-time streaming.

CMS 130 can further include analytics system 134 that can use AI/ML techniques to analyze input data 133 in real-time or near real-time and generate analysis output 135 based on the analysis. For example, analysis output 135 can provide an assessment of cybersecurity risk within a computing system. Additionally, analysis output 135 can be used to perform at least one action, either automatically without additional user interaction or by generating an alert to have a user perform at least one action. For example, the at least one action can include a remedial action to mitigate cybersecurity risk.

In some implementations, CMS 130 supports the use of a digital assistant accessible via a user interface to perform tasks. For example, a digital assistant can be a conversational AI platform that can receive a prompt from a user (e.g., user device within enterprise 112) via a user interface. In some implementations, the digital assistant graphically interfaces with the user via an interactive digital avatar. In some implementations, the user is granted access to CMS 130 by being authenticated using suitable user credentials. This can ensure that potentially sensitive data is protected from external entities. Once authenticated, the user can provide a prompt for the digital assistant.

CMS 130 can generate a command from the content of the prompt to use at least one ML model to provide a response based on stored data obtained from the multiple components/products within the computing system. The ML model can include a set of neural networks including an input layer and an output layer. The set of neural networks can further include one or more hidden layers. In some implementations the ML model is a deep learning model. In some implementations, an ML model includes a generative AI model. In some implementations, an ML model includes a language model. A language model can be trained on a corpus of text to generate human-like responses. For example, a language model can be a large language model (LLM) that can be trained on a large corpus of text. In some implementations, the ML model includes a generative pre-trained transformer (GPT) model. In some implementations, the generative AI model is a customized generative AI model for enterprise 112. More specifically, the generative AI model can be a private model that is trained on enterprise data, and is not available for public use. For example, the prompt can be a voice prompt that is converted into a command to use an ML model (e.g., using natural language processing (NLP)). As another example, the prompt can be a text prompt that is converted into a command to use an ML model (e.g., using NLP). For example, CMS 130 can split and tokenize the prompt into tokens with the use of NLP via an API call.

CMS 130 can then provide a response to the prompt. In some implementations, the response is a search result provided to the user (e.g., displayed to the user via a user interface). To do so, CMS 130 can then then make another API call to a search engine to perform a similarity search against a vector database's embeddings using a search method (e.g., k-nearest neighbor (KNN)) until it (1) finds relevant data to the prompt asked or (2) until it determines that the prompt is irrelevant with respect to the cybersecurity data. For example, CMS 130 can use the tokens generated by tokenizing the prompt to perform the search. More specifically, the vector database can be a data store that maintains vectorized data (e.g., vector embeddings) used to perform the search using the search engine.

In some implementations, the response includes a remediation action to be performed by CMS 130. For example, response can include a set of candidate actions presented to a user for selection. The digital assistant can receive a selection of an action from the set of candidate action. The digital assistant and then cause the selected action to be performed without additional user interaction. As another example, CMS 130 can automatically perform an action without additional user interaction (e.g., without providing the set of candidate actions to the user). For example, the action automatically performed by CMS 130 can be a highest ranked action among a set of candidate actions.

An example prompt is the question “Which subsidiary of the enterprise has the most security vulnerabilities?” In response, a ML model can be used by CMS 130 to analyze data related security vulnerabilities across subsidiaries 116 to determine at least one most vulnerable subsidiary. Another example prompt is the question “What are the five riskiest vendors across the computing system?” In response, an ML model can be used by CMS 130 to analyze data related to security vulnerabilities across vendors of the computing system to determine the five riskiest vendors of vendors 118.

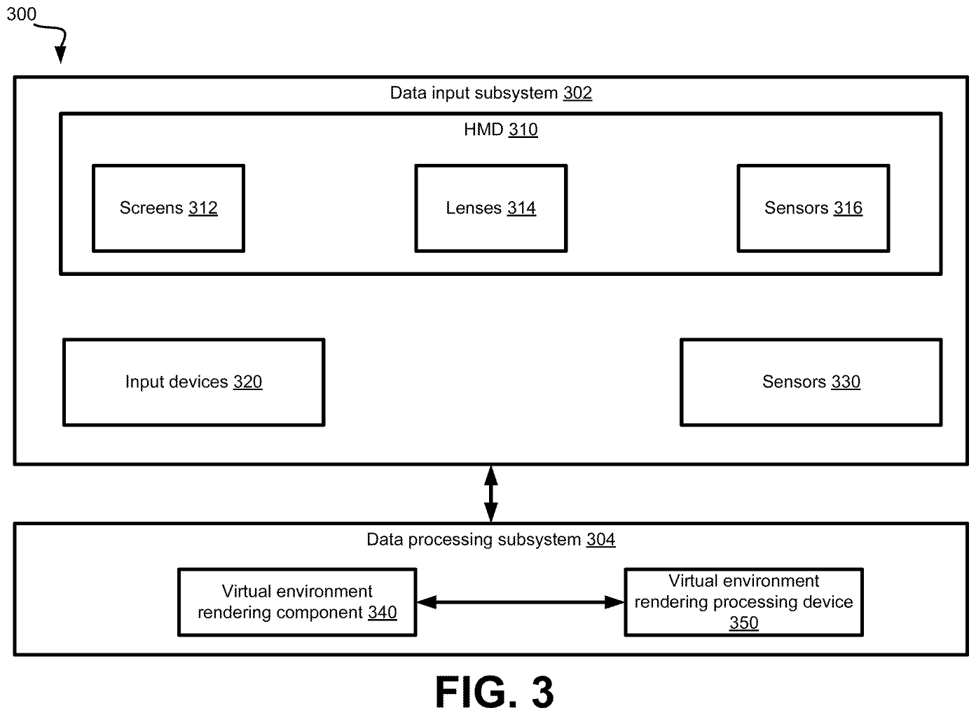

Additionally or alternatively, in some implementations, CMS 130 includes or interacts with an XR system. The XR system can enable access to a virtual environment to create an immersive virtual experience for a user, in which a user can observe and/or interact with the virtual environment. For example, in the case of VR, the virtual environment that can include one or more virtual worlds, where each virtual world is a 3D virtual space in which users can interact with other users and with digital objects. Users can create digital avatars that represent the users within a virtual world. Once inside a virtual world, users can perform various different types of activities, such as explore the virtual world, socialize with other users who are currently present within the virtual world, participate in games and activities supported by the virtual world, buy and sell virtual goods within a virtual marketplace supported by the virtual world, etc. For example, an HMD can be used by a user to view a dashboard (e.g., heatmap dashboard) in the virtual environment for visualizing various cybersecurity aspects of the enterprise (e.g., security risk posture). A virtual environment can be generated and maintained using a combination of technologies, such as AI, blockchain, etc. These technologies can enable the creation and storage of large amounts of data that can be used to populate the virtual worlds with digital content, such as digital objects, digital avatars, digital buildings, etc. Further details regarding the XR system will be described below with reference to FIG. 3. Further details regarding CMS 130, including ingestion system 132 and analytics system 134, will be described below with reference to FIG. 1C.

CMS 130 can be implemented using various CMS components. One example of a CMS component that can be included in CMS 130 are CI/CD components that can be used to automate at least a portion of software development related to a CI/CD pipeline. For example, the CI/CD components can include at least one of a code repository, a CI/CD DevOps application (e.g., Jenkins), a CI/CD repository manager, etc.

Another example of a CMS component that can be included in CMS 130 is a message queuing service. A message queuing service can be a system (e.g., message-oriented middleware (MOM)) that pushes messages into a queue using an asynchronous communication protocol.

Another example of a CMS component that can be included in CMS 130 is an API gateway to process API calls. The API gateway can handle tasks involved in accepting and processing API calls (e.g., hundreds of thousands of concurrent API calls). Examples of such tasks include traffic management, cross-original resource sharing (CORS) support, authorization and access control, throttling, monitoring, API version management, etc.

Another example of a CMS component that can be included in CMS 130 is a content delivery network (CDN) for distributing content to users of CMS 130. For example, the content can include a response to a prompt provided by a user of enterprise 112. the CDN can enable caching of static content, which can improve system performance.

Another example of a CMS component that can be included in CMS 130 is a certificate manager. The certificate manager can handle tasks related to creating, storing and/or renewing digital certificates, such as, e.g., Secure Sockets Layer (SSL) and/or Transport Layer Security (TLS) certificates. For example, a digital certificate can be an X.509 certificate.

FIG. 1B illustrates example types of cybersecurity management data sources 120, in accordance with some implementations. As shown, cybersecurity management data sources 120 can include configuration management database (CMDB) 121. CMDB 121 is a database that maintains information about IT components within an IT infrastructure of an enterprise (e.g., hardware, software, networks, applications, and services). Information about the components can include attributes, relationships, dependencies, etc. CMDB 121 can be a standalone database or a component within an application (e.g., an IT Service Management (ITSM) application). CMDB 121 can be populated manually or automatically through the use of applications that scan an IT infrastructure to obtain information about the IT components. CMDB 121 can be used to track changes to IT components, understand the impact of the changes, and manage the changes to ensure that IT services are reliably provided within system 100. Accordingly, CMDB 121 can be used to improve IT service delivery, reduce downtime, and increase the efficiency of IT operations.

As further shown, cybersecurity management data sources 120 can include Identity and Access Management (IAM) system (“IAM”) 122. IAM 122 can include technology to manage user access to resources. IAM 122 can help enterprises manage and control access to critical information and applications by providing a way to authenticate and authorize users and devices, and to manage their digital identities. IAM 122 can be implemented through hardware and/or software to interact with the IT infrastructure of an enterprise. IAM systems can be managed on-premises or remotely. IAM 122 can include features such as single sign-on, multi-factor authentication (MFA), role-based access control, and automated user provisioning and de-provisioning. IAM 122 can perform various processes for managing and controlling access to critical information and applications. Examples of processes include an identification process used to assign a unique digital identity (“identity”) to each object (e.g., user or device), an authentication process used to verify an identity of an object using authentication credentials, such as a password, biometric information, etc., an authorization process to determine which resources that an object is authorized to access and/or which actions that the object is authorized to perform, an accountability process to log and monitor activity (e.g., to determine whether security policies and compliance requirements are being met), etc.

As further shown, cybersecurity management data sources 120 can include firewall 123. Firewall 123 is a cybersecurity system that monitors and controls incoming and outgoing network traffic. For example, firewall 123 can include hardware and/or software that provides a security barrier between a trusted internal network (e.g., enterprise network) and an untrusted network external to the internal network (e.g., Internet) to prevent authorized against and to protect against cyberattacks. Firewall 123 can rely on a set of rules or polices to control incoming and outgoing network traffic, which can be based on IP address, port number, protocol type, content, etc. Firewall 123 can further analyze network traffic content (e.g., packet inspection) to determine whether the content is indicative of malicious activity. Firewall 123 can include at least one of a network firewall (e.g., hardware device that is located on the perimeter of the internal network), a host-based firewall (e.g., software firewall installed on individual devices within the internal network), or a next-generation firewall (e.g., a firewall that uses advanced security features such as intrusion prevention, application-level inspections, sandboxing, etc.)

As further shown, cybersecurity management data sources 120 can include Security Information & Event Management (SIEM) system (“SIEM”) 124. SIEM 124 can include hardware and/or software that can provide real-time monitoring, correlation, analysis, and reporting of security-related events within system 100. That is, SIEM 124 can be used to identify and respond to security incidents, such as data breaches, insider threats, malware infections, and unauthorized access attempts. SIEM 124 can also provide forensic analysis and compliance reporting. SIEM 124 can obtain security-related data from various sources, such as network devices, servers, applications, and security devices, aggregate the security-related data into a central repository, analyze the security-related data to detect an anomaly (e.g., potential security threat), and respond to an anomaly by performing a remedial action (e.g., generate an alert, automatically address the anomaly). Aggregating the security-related data can include normalizing the security-related data obtained from different sources. Security-related data can include logs, events, etc. SIEM 124 can detect anomalies in real-time or near real-time by utilizing analytics and/or AI/ML methods. Accordingly, SIEM 124 can be used to improve the security posture of computing system 110 and reduce the time to detect and respond to security incidents.

As further shown, cybersecurity management data sources 120 can include Endpoint Management (EM) system and/or Mobile Device Management (MDM) system (“EM/MDM”) 125. EM/MDM 125 can include hardware and/or software that can enable an enterprise to remotely monitor and/or manage use of user devices operated by users of system 100, such as endpoint devices and/or mobile devices, to ensure that the user devices are updated, secure and configured accordance with a set of policies (e.g., enterprise policies). Examples of endpoint devices and/or mobile devices include smartphones, laptops, tablets, etc. MDM can be used even with respect to devices that are not located on-premises. For example, EM/MDM 125 can support user device enrollment, policy enforcement, software distribution, and data protection. These features enable the use of security policies and access management to enterprise data and resources to prevent unauthorized access or theft, such as through the use password requirements, encryption, and remote data removal. EM/MDM 125 can be implemented on-premises or remotely. Accordingly, EM/MDM 125 can improve the security posture of system 100 by reducing the risk of data loss or theft.

As further shown, cybersecurity management data sources 120 can include Application Security (AppSec) system (“AppSec”) 126. AppSec 126 can perform various security activities related to identifying, mitigating, and preventing security vulnerabilities in software applications utilized within system 100 to prevent cyberattacks. Security activities can include threat modeling, vulnerability assessments, penetration testing, code analysis, and security testing. Such security activities can be used to identify a potential security vulnerability within an application (e.g., within source code), and perform an action to address the potential security vulnerability. For example, AppSec 126 can generate a recommendation for how to mitigate (e.g., remove) the potential security vulnerability, or can automatically perform an action to mitigation the potential security vulnerability without additional user interaction. In some implementations, AppSec 126 utilizes AI/ML to generate the recommendation and/or automatically perform the action. AppSec 126 can be used to perform security activities during the software development lifecycle (SDLC), such as by implementing security requirements into the design phase, performing security testing during development, and conducting regular security assessments and code reviews throughout the SDLC.

As further shown, cybersecurity management data sources 120 can include operational technology (OT) system and/or IoT system (“OT/IoT”) 127. An OT system can include hardware and/or software that can be used to monitor and control physical processes and devices within system 100. For example, OT can be used to control and automate industrial equipment and processes, such as assembly lines, conveyor belts, turbines, and control systems. OT can perform various types of functions, such as monitoring and controlling temperature, pressure, flow rates, and other physical parameters, and can operate with other control systems. OT can operate in real-time and can use special-purpose communication protocols and/or hardware. An IoT system refers to a system of connected devices (“IoT devices”) that can each obtain data (e.g., using a set of sensors) and transmit data to other loT devices of the IoT system over a network. Additionally or alternatively, an IoT device can include a set of actuators to perform an action based on the data. IoT systems enable a wide range of applications and services (e.g., “smart” applications and services) in various contexts, including homes, cities, industrial automation, healthcare monitoring, and transportation. For example, IoT 128 can include a physical layer including loT devices, a network layer to enable data transmission between the IoT devices, and an application layer that includes applications and/or services to analyze data obtained from the IoT devices and/or to cause an action to performed based on the data (e.g., using AI/ML). Security measures can be used to provide security for IoT 128, such as device authentication, encryption, and access control.

As further shown, cybersecurity management data sources 120 can include directory service 128. Directory service 129 is a service that can provide centralized management and authentication of objects, such as users, computers, printers, etc. within system 100. Directory service 128 can be used to store information about objects and enable administrators within system 100 to manage access to these objects based on specific policies and permissions. For example, directory service 128 can support single sign-on capability, so that users within system 100 can provide initial authentication credentials to access resources to which they have permission to access without requiring additional authentication credentials. Besides authentication and authorization services, directory service 128 can provide additional services such as domain name service (DNS) resolution services, group policy management services, and certificate services.

As further shown, cybersecurity management data sources 120 can include DNS and/or Dynamic Host Configuration Protocol (DHCP) server (“DNS/DHCP”) 129. A DNS is a system that translates domain names into an IP address to enable communication between computers. For example, when a user enters a domain name corresponding to a website into a web browser, the web browser can send a request to a DNS resolver to identify the IP address correspond to the domain name. The DNS resolver can then query DNS servers to locate the IP address for the domain name and return the IP address to the web browser. The web browser can then use the IP address to connect to a web server that hosts the website. DHCP is a network protocol used to assign network configuration parameters (e.g., IP addresses, subnet masks, gateways, DNS server information) to network devices. For example, a DHCP server can receive a request from a device connecting to a network, and provide the network configuration parameters for the device in response. The device can then use its assigned network configuration parameters to communicate with other devices within the network.

Examples of data can that can be collected from components of the IT infrastructure include vulnerability assessment data, CMDB data associated with CMDB 121, IAM data associated with IAM 122, firewall data associated with firewall 123, SIEM data associated with SIEM 124, MDM data associated with MDM 125, AppSec data associated with AppSec 126, OT management data and/or IoT management data associated with OT/IoT 127, directory service data associated with directory service 128, DNS data and/or DHCP data associated with DNS/DHCP 129, and/or threat intelligence data, such as penetration testing data associated with a penetration test (e.g., a simulated cyberattack that is used to identify and/or exploit security vulnerabilities before an actual cyberattack occurs).

FIG. 1C illustrates an example CMS 130, in accordance with some implementations of the present disclosure. For example, ingestion system 132 can include data lake 140. Data lake 140 is a centralized repository that enables storage of data obtained from structure data sources 210, unstructured data sources 220 and/or semi-structured data sources 230. Data in data lake 140 can be stored in a native format, without any pre-defined structure or schema. Accordingly, data lake 140 can store a variety of different data types. Data lake 140 can enable an enterprise to store and analyze large volumes of data from a variety of sources in a flexible and cost-effective way. Since data can be stored in its original format, data can be accessed and analyzed by different applications, allowing for more efficient and effective data analysis. Data lake 140 can include integrated AI/ML applications that can be used to identify data patterns. Data lake 140 can further include an object storage system (“object store”). An object store can manage data as respective objects, as opposed to other data storage systems such as hierarchical file systems. Each object can be assigned a unique identifier, and the data is stored along with metadata describing the object and attributes. This metadata can include object information such as creation date, size, type, and access permissions. Object stores can be to store unstructured data, such as documents, images, videos, and audio files, that need to be accessed and manipulated by multiple users and applications. Object stores can be designed to be highly scalable, fault-tolerant, and flexible, allowing users to easily add or remove data without affecting overall system performance.

Ingestion system 132 can include data processing component 150 that can process data stored in data lake 140, and store the processed data in data warehouse 160. For example, processing the data can include transforming the data to conform to a consistent schema. Data warehouse 160 is centralized repository of data (e.g., structured and curated data) that is designed to work with analytics system 134 to support business intelligence (BI) activities such as data analysis, reporting, and decision-making. In contrast to data lake 140, data warehouse 160 can be used to store data in a pre-defined, structured format that is optimized for querying and analysis of data. Data warehouse 160 can include features to improve query performance, such as data aggregation, data summarization, data indexing, etc. Additionally, data warehouse 160 can include a number of mechanisms to improve data quality and consistency, such as data validation, data cleansing, etc.

As another example, processing the data can include vectorizing the data to generate respective vector embeddings and the data warehouse 160 includes a vector database maintaining the vector embeddings. A vector embedding is a representation of data as a numerical vector (e.g., array of values) that captures meanings and/or relationships. Vector embeddings can be used to improve the ability of a computing system to retrieve information.

Analytics system 134 can include Cyber Risk Quantification (CRQ) engine 170. CRQ refers to techniques for quantifying cybersecurity risk, such as determining the potential impact that a cyberattack can have on system 200 (e.g., the enterprise). Techniques for quantifying cybersecurity risk can include risk assessment techniques. Risk assessment techniques generally involve analyzing a set of cybersecurity risk factors, such as assets, security vulnerabilities, malicious actors, likelihood of different types of cyberattacks, and/or potential impact of different types of cyberattacks (e.g., severity of cyberattacks). Analytics system 134 can also be used to determine cybersecurity strategies to account for these potential impacts and/or implement the cybersecurity strategies to improve cybersecurity within system 200. One example of a risk assessment technique is qualitative risk assessment. Qualitative risk assessment uses qualitative analysis to evaluate the likelihood and/or impact of different types of cyberattacks based on relevant information, such as expert opinion and/or historical data. For example, a cybersecurity administrator or team of an enterprise can perform a risk assessment. Another example of a risk assessment technique is quantitative risk assessment. Quantitative risk assessment uses quantitative analysis to evaluate the likelihood and/or impact of different types of cyberattacks based on relevant information. For example, quantitative risk assessment can involve generating and/or utilizing risk assessment models that can be used to determine, from the relevant information, the likelihood and/or impact of different types of cyberattacks. For example, risk assessment models can include machine learning models that are trained to determine the likelihood and/or impact of different types of cyberattacks based on input data including relevant information. One type of quantitative risk assessment is probabilistic risk assessment, which involves using probabilistic models to determine the likelihood and/or potential impact of different types of cyberattacks. For example, a probabilistic model can simulate different cyberattack scenarios and calculate the probability of each cyberattack scenario occurring, as well as the potential impact of each cyberattack scenario. Additional functionality supported by the analytics system 134 can include automated inventory of technology assets of system 200, identifying risk of objects of system 200 (e.g., users and/or devices) based on object attributes (e.g., object identity), integrated cybersecurity threat feeds, technology asset criticality analyses for technology assets based on criticality of workloads and assets in risk calculations, prioritization of security vulnerabilities based on factors such as severity, threat type, exposure, security controls and the technology asset criticality analyses, etc.

Additionally or alternatively, analytics system 134 can further include one or more advanced analytics applications 180. For example, advanced analytics application(s) 180 can include an exploratory analysis application to perform exploratory analysis (e.g., data discovery). Exploratory analysis refers to analyzing and summarizing data in order to derive an understanding of patterns, relationships, and/or structure within the data. Exploratory analysis can include summarizing data by extracting key information from data and presenting the key information in a concise format. For example, summarizing data can include implementing one or more data summarization techniques such as descriptive statistics (e.g., using statistical measures to summarize data, data visualization (e.g., representing data in a graphical form), data aggregation (e.g., combining individual data points into groups to provide a summarization of the data), data sampling (e.g., analyzing a representative subset of the data instead of an entire dataset), etc.

As another example, advanced analytics application(s) 180 can include a predictive modeling application to perform a set of predictive modeling processes. Predictive modeling is the process of using statistical and machine learning techniques to develop predictive models that can predict future outcomes based on historical data. Predictive models are typically used to make predictions or forecasts about future events or behaviors based on patterns and relationships within data. The set of predictive modeling processes can include data collection to collect and organize relevant data for training a predictive model, data preparation to preprocess (e.g., clean) the data to remove errors or inconsistencies that can affect predictive model accuracy, feature selection to identify features from the data that are most relevant with respect to a prediction made by the prediction model (e.g., have the greatest impact on the predicted outcome), model training to train the predictive model on historical data, model validation to test the accuracy of the predictive model post-training using a non-training dataset, and/or model deployment to deploy a validated predictive model.

Additionally or alternatively, analytics system 134 can further include one or more data intelligence applications 190. Data intelligence application(s) 190 can intelligently collect, analyze and/or present data. For example, data can be presented in a manner to enable decision-makers to make informed and effective data-driven decisions. For example, data intelligence application(s) 190 can include a dashboard application that provides a dashboard. A dashboard is a graphical user interface (GUI) that can monitor and track enterprise performance in real-time or near real-time. For example, a dashboard can be used to display metrics, such as key performance indicators (KPIs) of an enterprise.

As another example, data intelligence application(s) 190 can include a data reporting application. A data reporting application can be used to generate and distribute data reports. A data report can be generated in any suitable format. A data reporting application can be used to schedule data report generation at time intervals.

As yet another example, data intelligence application(s) 190 can include a data visualization application. A data visualization application can be used to generate an interactive visual representation of data (e.g., graph, chart and/or map).

As yet another example, data intelligence application(s) 190 can include an operational intelligence application that can improve operational processes and decision-making within an enterprise (e.g., using real-time or near real-time). An operational intelligence application can be used to detect and respond to problems and/or identify ways to improve operations.

As yet another example, data intelligence application(s) 190 can include an integration application to perform one or more types of integration for improved efficiency. Integration refers to a process of connecting different applications within a unified system in order. One type of integration is data integration to connect different data sources (e.g., databases) for data sharing and/or data synchronization. Another type of integration is API integration to connect different applications in order to enable data and functionality to flow seamlessly between the different applications. Yet another type of integration is enterprise service bus (ESB) integration to connect different components (e.g., systems and applications) by transforming messages into a common messaging framework.

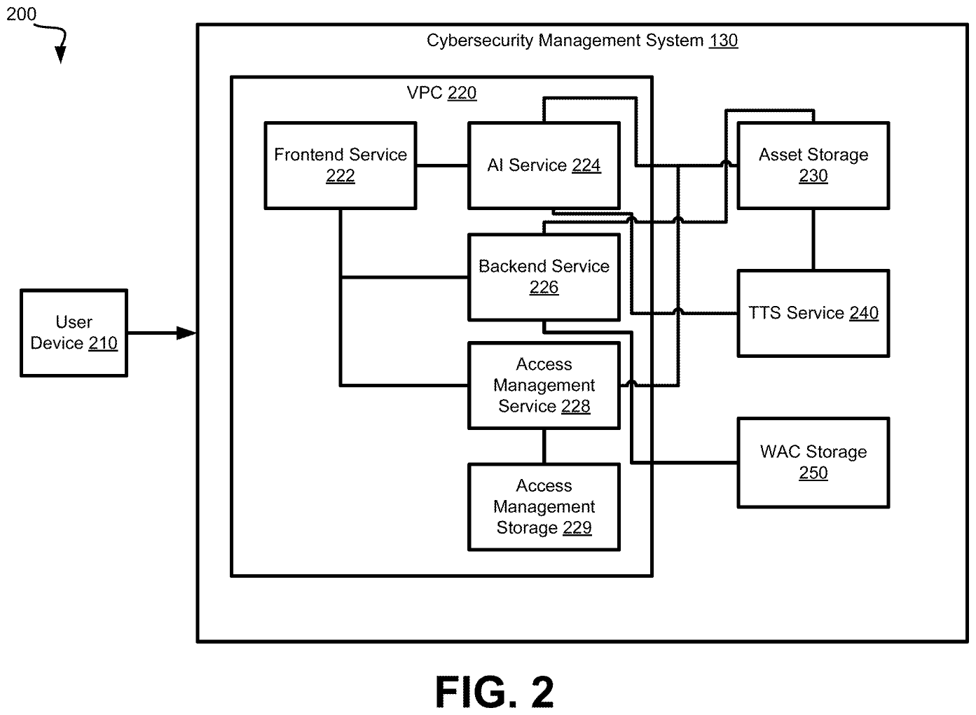

FIG. 2 is a diagram of an example computer system 200 to manage cybersecurity integrating AI, ML and XR, in accordance with some implementations of the present disclosure. As shown, the system 200 can include a user device 210 and CMS 130. CMS 130 can implement a service-oriented architecture, in which a cybersecurity management application is arranged as a collection of independent application services (“services”) that communicate with each other through protocols. In some implementations, a service is a microservice. Examples of cybersecurity management applications include digital assistants, XR applications, etc.

For example, CMS 130 can include a virtual private cloud (VPC) 220. The VPC 220 is a secure, logically isolated private section of a public cloud environment that is hosted remotely by the provider of the public cloud environment.

For example, the VPC 220 can maintain a set of application services. The set of application services of the VPC 220 can include a frontend service 222, an AI service 224, a backend service 226, and an access management service 228. The VPC 220 can further include access management storage 229. The application services system 210 can further include asset storage 230, a text-to-speech (TTS) service 240 and world and access configuration (WAC) storage 250.

The frontend service 222 can be communicatively coupled to the AI service 224, the backend service 226 and the access management service 228. The frontend service 222 can implement logic for loading assets of CMS 130 (models, materials, animations, cameras, etc.) In some implementations, the frontend service 222 implements a container.

The AI service 224 can be communicatively coupled to the asset storage 230 and the TTS service 240. The AI service 224 can generate a response to a query received from the user device 210 that is related to cybersecurity. More specifically, the AI service 224 can use at least one ML model (e.g., a generative AI model) to generate the response.

The backend service 226 can be communicatively coupled to the frontend service 222, the asset storage 230 and the WAC storage 250. The backend service 226 can include logic for the storage of assets of the cybersecurity management system 130 (models, sounds, etc.). For example, assets can be stored within the asset storage 230.

The access management service 228 can be communicatively coupled to the frontend service 222, the asset storage 230 and the access management storage 229. The access management service 228 can include logic for access management (e.g., which entity has access to what component within the cybersecurity management system 130). Access management information can be maintained in the access management storage 229.

The TTS service 240 can enable developers of the cybersecurity management system 130 to add TTS capability to the cybersecurity management application.

Illustratively, assume that the cybersecurity management application is a virtual assistant or a chatbot. A user via the user device 210 can log into CMS 130 using credentials. Once authenticated, the user can send a query to be processed by the cybersecurity management application. For example, as described above with reference to FIG. 1A, the query can be split and tokenized into a set of tokens with the use of NLP via an API call, and the cybersecurity management application can then make another API call to cause a search engine (based on the set of tokens) to perform a similarity search against a vector database's embeddings using a search method (e.g., KNN) until it (1) finds relevant data to the prompt asked or (2) until it determines that the prompt is irrelevant with respect to the cybersecurity data.

FIG. 3 is a diagram of XR system (“system”) 300, in accordance with some implementations. System 300 can include data input subsystem 302 and data processing subsystem 304. Data input subsystem 302 can include a set of data collection components that can be used to obtain data from a user (e.g., user motion data, user input data), and data processing subsystem 304 can include a set of data processing components that can be used to process the data obtained from the user to cause actions to be performed within a virtual environment.

For example, data input subsystem 302 can include head-mounted display (HMD) 310. Examples of head-mounted displays include headsets, glasses, etc. HMD can include set of screens 312 (e.g., high-resolution display screens), set of lenses 314, and set of sensors 316. Set of screens 310 can include multiple screens (e.g., a pair of screens) that can collectively generate a 3D visual effect for the user. Set of lenses 314 can include lenses to help focus images and adjust for user interpupillary distance (i.e., distance between the centers of the user's eyes). Set of sensors 316 can be used to track the position and/or movement of HMD 310 and/or the user's head. Examples of sensors of set of sensors 316 can include accelerometers, gyroscopes, etc.

User subsystem 302 can further include set of input devices 320 that can allow the user to interact with the virtual environment. For example, set of input devices 320 can include at least one of: one or more hand controllers, one or more joysticks, etc. Data input subsystem 302 can further include set of sensors 330. More specifically, set of sensors 330 can include a set of motion tracking sensors to detect user movements and convert user movements into responses within the virtual environment. For example, set of sensors 330 can include one or more cameras to track the position and/or movement of the HMD and/or set of input devices 320, one or more inertial sensors to detect user movement, etc. Set of sensors 330 can be placed within a room to optimize movement detection.

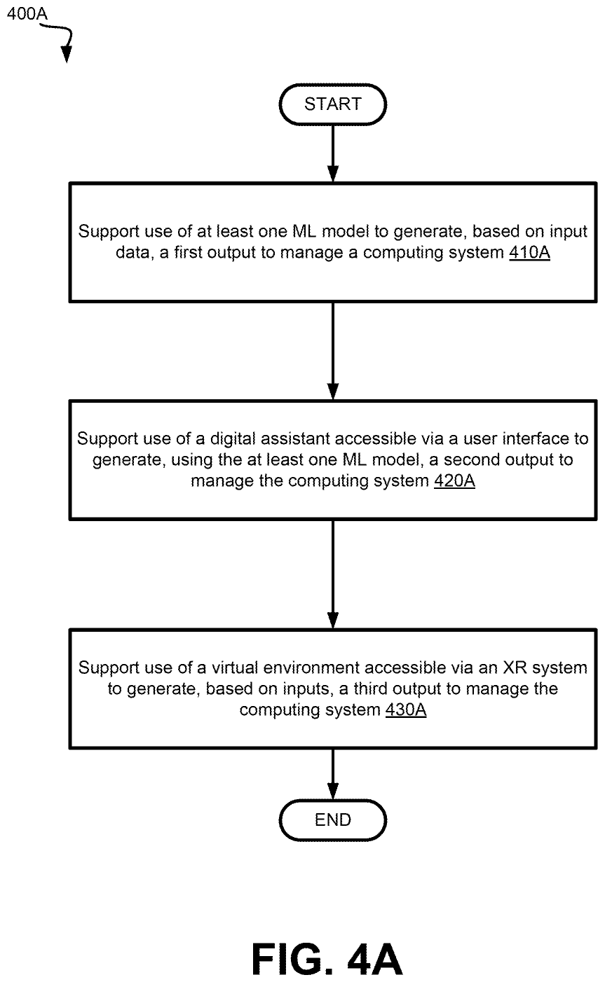

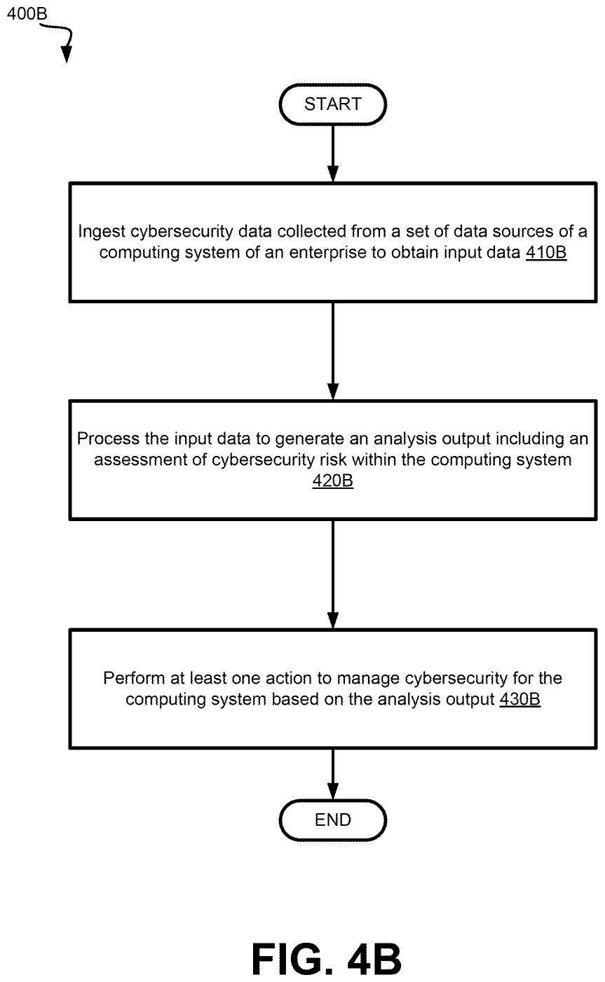

Data processing subsystem 304 can include virtual environment rendering component 340. Virtual environment rendering component 340 can be used to render a virtual environment that is realistic and immersive for the user, for XR applications (e.g., VR, AR and/or MR). Data processing subsystem 304 can utilize a high level of graphics processing power to render the virtual environment in real-time or near real-time. For example, data processing subsystem 304 can render the virtual environment in real-time or near real-time by implementing set of virtual environments rendering processing devices 350. Set of virtual environment rendering processing devices 350 can include hardware components, such as specialized graphics cards, high-performance processing units (e.g., central processing units (CPUs) and/or graphics processing units (GPUs), and/or other hardware components. Further details regarding XR system 300 are described above with reference to FIG. 1C and will be described in further detail below with reference to FIGS. 3-4.

FIG. 4A is a flow diagram of an example method 400A to implement a cybersecurity management system integrating AI, ML and XR, in accordance with some implementations of the present disclosure. Method 400A can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some implementations, method 400A is performed by one or more components of computing environment 100 of FIG. 1. Although shown in a particular sequence or order, unless otherwise specified, the order of the processes can be modified. Thus, the illustrated implementations should be understood only as examples, and the illustrated processes can be performed in a different order, and some processes can be performed in parallel. Additionally, one or more processes can be omitted in various implementations. Thus, not all processes are required in every implementation. Other process flows are possible.

At operation 410A, processing logic supports use of at least one ML model to generate, based on input data, a first output to manage a computing system. In some implementations, the first output manages cybersecurity within the computing system. In some implementations, the computing system is associated with an enterprise.

In some implementations, supporting the use of the at least one machine learning model to generate the first output includes generating the input data based on data collected from a set of data sources of a computing system. Each data source of the set of data sources generates data related to cybersecurity within the computing system. Examples of data can that can be collected from a set of data sources of the computing system include vulnerability assessment data, CMDB data associated with a CMDB, IAM data associated with an IAM, firewall data associated with a firewall, SIEM data associated with a SIEM, MDM data associated with an MDM, AppSec data associated with an AppSec system, OT management data associated with an OT system, IoT management data associated with an IoT system, directory service data associated with a directory service, DNS data associated with a DNS, DHCP data associated with a DHCP, and/or threat intelligence data, such as penetration testing data associated with a penetration test (e.g., a simulated cyberattack that is used to identify and/or exploit security vulnerabilities before an actual cyberattack occurs). The data collected from the set of data sources can have various different data types, such as application programming interface (API) feeds, database queries, unstructured data (e.g., PDF files, word processing document files, table-structured format files (e.g., CSV files), read-only API access to technology assets and data sources such as a public cloud infrastructure, etc. For example, the data collected from the set of data sources can include data associated with at least one of: the enterprise, one or more customers of the enterprise, one or more subsidiaries of the enterprise and/or one or more vendors of the enterprise.

In some implementations, the at least one ML model includes a language model trained on a corpus of text to generate an output capable of being interpreted by a user. For example, the output can be a text output. As another example, the output can be a voice output. In some implementations, the language model is an LLM. In some implementations the ML model includes a GPT model.

At operation 420A, processing logic supports use of a digital assistant accessible via a user interface to generate, using the at least one ML model, a second output to manage the computing system. In some implementations, the second output manages cybersecurity within the computing system. In some implementations, supporting the use of the digital assistant to generate the second output includes receiving a prompt via the user interface, converting the prompt into a command, and generating the second output using the at least one machine learning model in accordance with the command. For example, the prompt can be a text prompt. As another example, the prompt can be a voice prompt. In some implementations, the second output includes a response to the prompt. For example, the response to the prompt can be a text response viewable by a user. As another example, the response to the prompt can be a voice response. For example, the digital assistant can be a voice assistant that utilizes speech recognition software to convert a voice prompt into text. More specifically, the speech recognition software can analyze features of the prompt (e.g., patterns and/or sounds) and match the features of the prompt to known words and phrases. Once the voice prompt has been converted into text, the voice assistant can use NLP to understand the meaning behind the words by analyzing structure and/or context within the text. The voice assistant can then use intent recognition to identify intent from the NLP analysis. The voice assistant can then generate the second output that appropriate responds to the prompt in view of the intent.

At operation 430A, processing logic supports use of a virtual environment accessible via an XR system to generate, based on inputs, a third output to manage the computing system. In some implementations, the third output manages cybersecurity within the computing system. More specifically, the inputs can be obtained from a data input subsystem of the XR system. A user can interact with the virtual environment via the data input subsystem, and the input data obtained via the data input subsystem can be used to modify the virtual environment based on movement of the user and/or the HMD. For example, the data input subsystem can include an HMD (e.g., headset or glasses), a set of input devices and a set of sensors. A user can interact with the virtual environment via the HMD and the set of input devices, and the set of sensors can be used to modify the virtual environment based on movement of the user and/or the HMD. Supporting the use of the virtual environment can include causing the virtual environment to be rendered using the set of virtual environment rendering processing device. For example, the virtual environment can be rendered and/or modified in real-time or near real-time by implementing the set of virtual environment rendering processing devices. The set of virtual environment rendering processing devices can include hardware components, such as specialized graphics cards, high-performance CPUs, and/or other hardware components.

In some implementations, at least one of the first output, the second output, or the third output includes at least one remedial action performed without additional user interaction to address at least one cybersecurity threat identified within the computing system. In some implementations, at least one of the first output, the second output, or the third output includes an alert indicative of at least one cybersecurity threat identified within the computing system. In some implementations, at least one of the first output, the second output, or the third output includes a set of candidate actions to address at least one cybersecurity threat identified within the computing system. Further details regarding operations 410A-430A are described above with reference to FIGS. 1A-2 and will now be described in further detail below with reference to FIG. 4B.

FIG. 4B is a flow diagram of an example method 400B to implement a cybersecurity management system integrating AI, ML and XR, in accordance with some implementations of the present disclosure. Method 400B can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some implementations, method 400B is performed by one or more components of computing environment 100 of FIG. 1. Although shown in a particular sequence or order, unless otherwise specified, the order of the processes can be modified. Thus, the illustrated implementations should be understood only as examples, and the illustrated processes can be performed in a different order, and some processes can be performed in parallel. Additionally, one or more processes can be omitted in various implementations. Thus, not all processes are required in every implementation. Other process flows are possible.

At operation 410B, processing logic ingests cybersecurity data collected from a set of data sources of a computing system of an enterprise to obtain input data. The cybersecurity data can be collected from a broad range of data sources within the computing system. For example, the data sources can include IT components (e.g., systems and/or applications). The data may be in various formats, such as structured, semi-structured, or unstructured. Examples of data types include API feeds, database queries, PDF files, word processing document files, table-structured format files (e.g., CSV files), read-only API access to technology assets and data sources such as a public cloud infrastructure, etc. Examples of cybersecurity data can that can be obtained from the set of data sources include vulnerability assessment data, CMDB data associated with a CMDB, IAM data associated with an IAM, firewall data associated with a firewall, SIEM data associated with a SIEM, MDM data associated with an MDM, AppSec data associated with an AppSec system, OT management data associated with an OT system, IoT management data associated with an loT system, directory service data associated with a directory service, DNS data associated with a DNS, DHCP data associated with a DHCP, and/or threat intelligence data, such as penetration testing data associated with a penetration test (e.g., a simulated cyberattack that is used to identify and/or exploit security vulnerabilities before an actual cyberattack occurs). Ingesting the cybersecurity data can include extracting raw data from the set of data sources, and transforming the raw data. More specifically, the input data can include a set of transformed data, in which each data item of the set of extracted data is transformed into a data format suitable for managing the computing system. Transforming the set of extracted data can include at least one of data cleaning, data validation, data normalization, or data enrichment. During the loading stage, the input data is loaded into a data storage system (e.g., database). For example, loading the input data can include performing batch processing or real-time streaming.

At operation 420B, processing logic processes the input data to generate an analysis output. Processing the input data can include analyzing the ingested cybersecurity data in real-time or near real-time. In some implementations, processing the input data includes generating an assessment of cybersecurity risk within the computing system. In some implementations, processing the input data includes determining a likelihood of a cyberattack within the computing system. For example, determining a likelihood of a cyberattack within the computing system includes obtaining a set of risk element risks by assigning a risk element risk to each risk element identified within the computing system, determining, for each technology asset of the computing system, a respective cyberattack scenario probability for the technology asset based on the set of risk element risks, and aggregating each cyberattack scenario probability to obtain the likelihood of the cyberattack within the computing system. Examples of risk elements include technology assets, policies, controls, objects (e.g., users and/or devices), third parties, etc. For example, processing the input data can include using CRQ techniques to quantify cybersecurity risk and/or determine the potential impact that a cyberattack can have on the computing system.

In some implementations, processing the input data includes using a ML model to generate the analysis output based at least in part on the input data. More specifically, the ML model can be trained to generate the analysis output based at least in part on the input data. In some implementations, the ML model is trained using supervised learning (e.g., using annotated training data). In some implementations, the ML model is trained using unsupervised learning. In some implementations, the ML model is trained using semi-supervised learning. In some implementations, the ML model is trained using reinforcement learning.

At operation 430B, processing logic performs at least one action to manage cybersecurity for the computing system based on the analysis output. For example, the at least one action can be visualizing cybersecurity risk data. As another example, the at least one action can be a remedial action to mitigate cybersecurity risk. In some implementations, the at least one action includes an action that is performed automatically without additional user interaction. In some implementations, the at least one action includes an action that is performed with additional user input (e.g., automatically or manually). For example, performing the at least one action can include generating an alert to have a user perform at least one action.

In some implementations, performing the at least one action includes implementing a digital assistant. For example, a digital assistant can be a conversation AI platform (e.g., interactive digital avatar or chatbot) that can receive a prompt from a user, and generate a command from the content of the prompt to use an ML model (e.g., generative AI model) to generate an output based on stored data obtained from the multiple components/products within the computing system. For example, the digital assistant can cause a visualization of cybersecurity data to be presented to a user. As another example, the digital assistant can cause at least one remedial action to be performed to mitigate cybersecurity risk.

In some implementations, performing the at least one action includes implementing an XR system. For example, the XR system can cause a visualization of cybersecurity data to be presented to a user within a virtual environment. In some implementations, performing the at least one action includes receiving a command to perform an action via an XR system. For example, the command can be received via an input device operated by a user. The analysis output can be provided to the user within the virtual environment via an HMD that enables user observation and/or interaction with the virtual environment (e.g., displayed on a display of the HMD). For example, the user can view a dashboard (e.g., heatmap dashboard) displayed within the virtual environment, and the user can provide a command to perform an action based on the information shown in the dashboard. Further details regarding operations 410B-430B are described above with reference to FIGS. 1A-3.

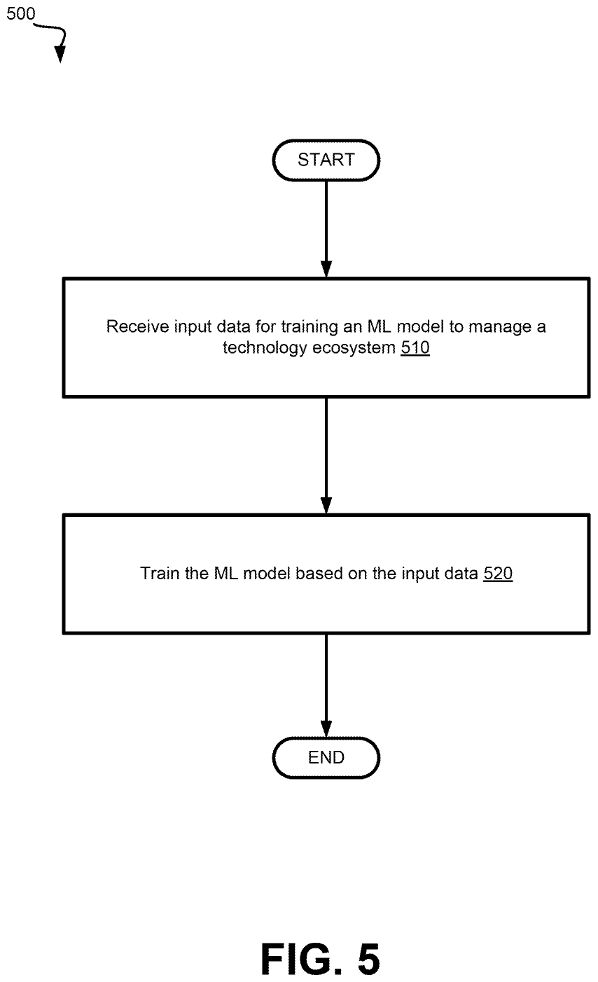

FIG. 5 is a flow diagram of an example method 500 to train an ML model to manage a computing system integrating AI, ML and XR, in accordance with some implementations of the present disclosure. Method 500 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some implementations, method 500 is performed by one or more components of computing environment 100 of FIG. 1. Although shown in a particular sequence or order, unless otherwise specified, the order of the processes can be modified. Thus, the illustrated implementations should be understood only as examples, and the illustrated processes can be performed in a different order, and some processes can be performed in parallel. Additionally, one or more processes can be omitted in various implementations. Thus, not all processes are required in every implementation. Other process flows are possible.

At operation 510, processing logic receives input data for training a ML model to manage a computing system and, at operation 520, processing logic trains the ML model based on the input data. For example, the ML model can be trained to manage cybersecurity within the computing system. The ML model can include a set of neural networks including an input layer and an output layer. The set of neural networks can further include one or more hidden layers. In some implementations the ML model is a deep learning model. In some implementations, an ML model is a language model. For example, a language model can be an LLM that can be trained on a large corpus of text. In some implementations, the ML model is a GPT model.

In some implementations, the ML model is trained using supervised learning. A supervised learning method utilizes labeled training datasets to train a machine learning model to make predictions. More specifically, a supervised learning method can be provided with input data (e.g., features) and corresponding output data (e.g., target data), and the ML model learns to map the input data to the output data based on the examples in the labeled dataset. For example, to train the ML to perform a classification, the input data can include various attributes of an object or event, and the output data may be a label or category. The labeled dataset would contain examples of these objects or events along with their corresponding labels. The ML model would be trained to map the input data to the correct label by analyzing the examples in the labeled dataset. Examples of supervised learning methods include linear regression learning, logistic regression learning, decision tree learning, support vector machine (SVM) learning, k-nearest neighbor (KNN) learning, gradient boosting learning, etc.

In some implementations, the ML model is trained using unsupervised learning. An unsupervised learning method trains a machine learning model to make predictions without using labeled training datasets. More specifically, a supervised learning method can be provided with input data (e.g., features) without corresponding output data (e.g., target data), and the ML model learns to map the input data to output data by identifying relationships (e.g., patterns) within the input data. For example, identifying relationships within the input data can include identifying groups of similar datapoints (e.g., clusters), or underlying structures within the input data. Examples of unsupervised learning methods include clustering (e.g., k-means clustering, principal component analysis (PAC), autoencoding, etc.

In some implementations, the ML model is trained using semi-supervised learning. In contrast to supervised learning where the input data includes only labeled training datasets, and unsupervised learning where the input data does not include any labeled training datasets, semi-supervised learning involves training a ML model to make predictions using datasets that include a combination of labeled data and unlabeled data. Semi-supervised learning can be used to improve the accuracy of the ML model, such as in cases where obtaining a labeled data is expensive and/or time-consuming. For example, a labeled training dataset can be used to learn the structure of a machine learning modeling problem, and the unlabeled training dataset can be used to identify general features of the data. Examples of semi-supervised learning methods include self-training, co-training, and multi-view learning.

Self-training refers to a method in which labeled data of a dataset is used to train an initial ML model, and the initial ML model is then used to make label predictions for unlabeled data of the dataset. The most confidently predicted outputs can be added to the labeled data to obtain an expanded dataset, the ML model can then be retrained on the expanded dataset. The training process can stop when there is no additional improvement to ML model performance.

Co-training refers to a method in which each ML model of a group of ML models (e.g., a pair of ML models) is trained on a respective subset of labeled data of a dataset to predict labels of unlabeled data of the dataset. For example, each ML model can be a classifier model. The most confidently predicted outputs can be added to the labeled data to obtain an expanded dataset, and each ML model can be retrained using the expanded dataset. The training process can stop when each ML of the group of ML models converges and/or when there is no additional improvement to ML model performance.

Multi-view learning refers to a method in which multiple ML models are each trained on a respective view of data. Each view of data can be obtained in a particular way, such as using different feature representations, different sensors, or different modalities. The individual predictions made by the ML models can then be combined to make a final prediction.

In some implementations, the ML model is trained using reinforcement learning. A reinforcement learning method involves an agent interacting with an environment to learn a policy of how to take actions that maximize rewards or minimize penalties. More specifically, a policy is a data structure mapping states (e.g., observations) to actions to maximize rewards or minimize penalties. In reinforcement learning, the agent learns by trial and error, receiving feedback from the environment in the form of rewards or penalties based on its actions and updating the policy based on the feedback. Reinforcement learning method use various methods to balance exploration (trying new actions to learn) and exploitation (using actions that have worked well in the past) to achieve optimal performance.

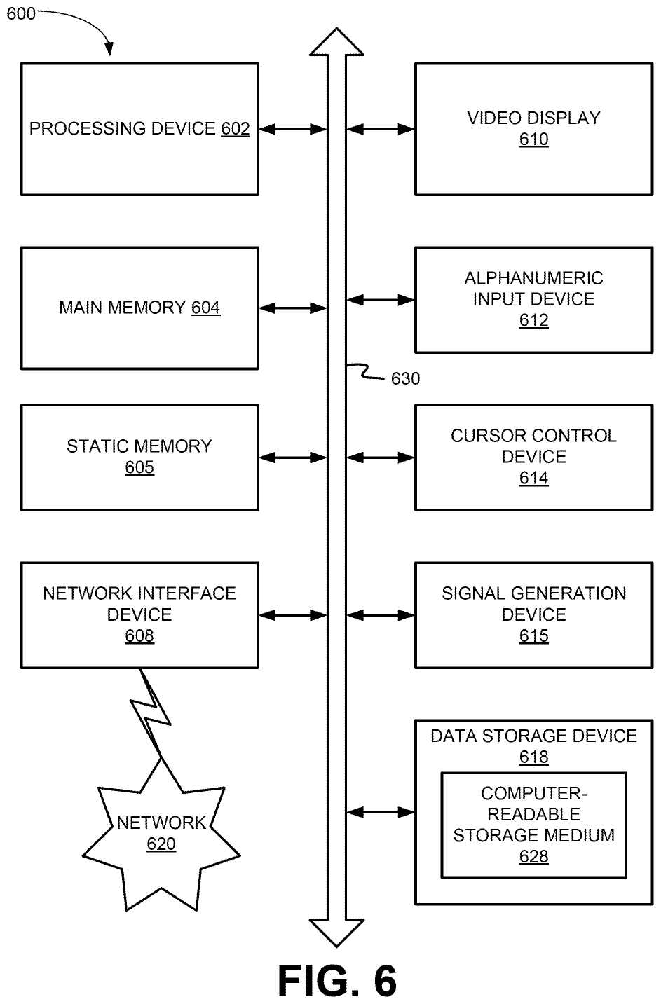

FIG. 6 illustrates a diagrammatic representation of a computer system 600, which may be employed for implementing the methods described herein. The computer system 600 may be connected to other computing devices in a LAN, an intranet, an extranet, and/or the Internet. The computer system 600 may operate in the capacity of a server machine in a client-server network environment. The computer system 600 may be provided by a personal computer (PC), a set-top box (STB), a server, a network router, switch or bridge, or any machine capable of executing a set of instructions (sequential or otherwise) that specify actions to be taken by that machine. Further, while only a single computing device is illustrated, the term “computer system” shall also be taken to include any collection of computing devices that individually or jointly execute a set (or multiple sets) of instructions to perform the methods discussed herein. In illustrative examples, the computer system 600 may represent one or more servers of the system 100 (e.g., CMS 130) implementing methods 400A-500.

The example computer system 600 may include a processing device 602, a main memory 604 (e.g., synchronous dynamic random access memory (DRAM), read-only memory (ROM)), and a static memory 605 (e.g., flash memory and a data storage device 618), which may communicate with each other via a bus 630.

The processing device 602 may be provided by one or more general-purpose processing devices such as a microprocessor, central processing unit, or the like. In an illustrative example, the processing device 602 may comprise a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 602 may also comprise one or more special-purpose processing devices such as an application specific integrated circuit (ASIC), a field programmable gate array (FPGA), a digital signal processor (DSP), a network processor, or the like. The processing device 602 may be configured to execute methods of managing computing systems, in accordance with one or more aspects of the present disclosure.

The computer system 600 may further include a network interface device 608, which may communicate with a network 620. The computer system 600 also may include a video display unit 610 (e.g., a liquid crystal display (LCD) or a cathode ray tube (CRT)), an alphanumeric input device 612 (e.g., a keyboard), a cursor control device 614 (e.g., a mouse) and/or an acoustic signal generation device 615 (e.g., a speaker). In some implementations, video display unit 610, alphanumeric input device 612, and cursor control device 614 may be combined into a single component or device (e.g., an LCD touch screen).

The data storage device 618 may include a computer-readable storage medium 628 on which may be stored one or more sets of instructions (e.g., instructions of the methods of automated review of communications, in accordance with one or more aspects of the present disclosure) implementing any one or more of the methods or functions described herein. The instructions may also reside, completely or at least partially, within main memory 604 and/or within processing device 602 during execution thereof by computer system 600, main memory 604 and processing device 602 also constituting computer-readable media. The instructions may further be transmitted or received over a network 620 via network interface device 608.

While computer-readable storage medium 628 is shown in an illustrative example to be a single medium, the term “computer-readable storage medium” shall be taken to include a single medium or multiple media (e.g., a centralized or distributed database and/or associated caches and servers) that store one or more sets of instructions. The term “computer-readable storage medium” shall also be taken to include any medium that is capable of storing, encoding or carrying a set of instructions for execution by the machine and that causes the machine to perform the methods described herein. The term “computer-readable storage medium” shall accordingly be taken to include, but not be limited to, solid-state memories, optical media and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some implementations, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, implementations of the disclosure have been described with reference to specific example implementations thereof. It will be evident that various modifications can be made thereto without departing from the broader spirit and scope of implementations of the disclosure as set forth in the following claims. The specification and drawings are, accordingly, to be regarded in an illustrative sense rather than a restrictive sense.

What is claimed is:

1. A method comprising:
ingesting, by a processing device, cybersecurity data collected from a set of data sources of a computing system of an enterprise to obtain input data, wherein each data source of the set of data sources generates data related to cybersecurity within the computing system;
processing, by the processing device, the input data to generate an analysis output comprising an assessment of cybersecurity risk within the computing system; and
performing, by the processing device based on the analysis output, at least one action to manage cybersecurity for the computing system, wherein performing the at least one action comprises at least one of:
using a digital assistant for managing the cybersecurity of the computing system; or
using an extended reality system to access a virtual environment for managing the cybersecurity of the computing system.

2. The method of claim 1, wherein ingesting the cybersecurity data to obtain the input data further comprises generating the input data by transforming the cybersecurity data.

3. The method of claim 1, wherein the digital assistant is implemented as an interactive digital avatar.

4. The method of claim 1, wherein the digital assistant is implemented as a chatbot.

5. The method of claim 1, wherein using the digital assistant to generate the output further comprises:
receiving a prompt via a user interface;
converting the prompt into a command; and
generating the analysis output using at least one machine learning model in accordance with the command.

6. The method of claim 5, wherein the output comprises at least one remedial action performed without additional user interaction to address at least one cybersecurity threat identified within the computing system in accordance with the prompt.

7. The method of claim 5, wherein the output comprises an alert indicative of at least one cybersecurity threat identified within the computing system in accordance with the prompt.

8. A system comprising:
memory; and
at least one processing device, operatively coupled to the memory, to perform operations comprising:
ingesting cybersecurity data collected from a set of data sources of a computing system of an enterprise to obtain input data;
processing the input data to generate an analysis output; and
performing, based on the analysis output, at least one action to manage cybersecurity for the computing system, wherein performing the at least one action comprises at least one of:
using a digital assistant for managing the cybersecurity of the computing system; or
using an extended reality system to access a virtual environment for managing the cybersecurity of the computing system.

9. The system of claim 8, wherein ingesting the cybersecurity data to obtain the input data further comprises generating the input data by transforming the cybersecurity data.

10. The system of claim 8, wherein the digital assistant is implemented as an interactive digital avatar.

11. The system of claim 8, wherein the digital assistant is implemented as a chatbot.

12. The system of claim 8, wherein using the digital assistant to generate the output further comprises:
receiving a prompt via a user interface;
converting the prompt into a command; and
generating the analysis output using at least one machine learning model in accordance with the command.

13. The system of claim 12, wherein the output comprises at least one remedial action performed without additional user interaction to address at least one cybersecurity threat identified within the computing system in accordance with the prompt.

14. The system of claim 12, wherein the output comprises an alert indicative of at least one cybersecurity threat identified within the computing system in accordance with the prompt.

15. A non-transitory computer-readable storage medium storing instructions which, when executed, cause a processing device to perform operations comprising:
ingesting cybersecurity data collected from a set of data sources of a computing system of an enterprise to obtain input data;
processing the input data to generate an analysis output; and
performing, based on the analysis output, at least one action to manage cybersecurity for the computing system, wherein performing the at least one action comprises at least one of:
using a digital assistant for managing the cybersecurity of the computing system; or
using an extended reality system to access a virtual environment for managing the cybersecurity of the computing system.

16. The non-transitory computer-readable storage medium of claim 15, wherein ingesting the cybersecurity data to obtain the input data further comprises generating the input data by transforming the cybersecurity data.

17. The non-transitory computer-readable storage medium of claim 15, wherein the digital assistant is implemented as an interactive digital avatar or a chatbot.

18. The non-transitory computer-readable storage medium of claim 15, wherein using the digital assistant to generate the output further comprises:
receiving a prompt via a user interface;
converting the prompt into a command; and
generating the analysis output using at least one machine learning model in accordance with the command.

19. The non-transitory computer-readable storage medium of claim 18, wherein the output comprises at least one remedial action performed without additional user interaction to address at least one cybersecurity threat identified within the computing system in accordance with the prompt.

20. The non-transitory computer-readable storage medium of claim 18, wherein the output comprises an alert indicative of at least one cybersecurity threat identified within the computing system in accordance with the prompt.
